(19) United States
(12) Patent Application Publication
(10) Pub. No.: US 2021/0192872 A1
(43) Pub. Date: Jun. 24, 2021

(54) MODEL DIAGNOSIS DEVICE AND MODEL DIAGNOSIS SYSTEM

(71) Applicant: TOYOTA JIDOSHA KABUSHIKI KAISHA, Aichi-ken (JP)

(72) Inventors: Hiroki MORITA, Hiratsuka-shi (JP); Daiki YOKOYAMA, Gotemba-shi (JP)

(21) Appl. No.: 17/105,506

(22) Filed: Nov. 26, 2020

(30) Foreign Application Priority Data
Dec. 19, 2019 (JP) 2019-229373

(51) Int. Cl. G07C 5/08; B60R 16/023; G06N 3/08

(52) U.S. Cl. CPC G07C 5/0808; G06N 3/08; B60R 16/0232

(57) ABSTRACT

A model diagnosis device includes a communication device able to communicate with a plurality of vehicles in each of which learning of a neural network model is performed and a learned neural network model is generated, a storage device, and a control device judging abnormality of the learned neural network model. The control device stores values of an output parameter output from the learned neural network model for predetermined values of input parameters in the storage device, when receiving a new learned neural network model or a value of an output parameter output from the new learned neural network model for the predetermined values of the input parameters from one vehicle of the plurality of vehicles through the communication device, performs statistical processing on the value of the output parameter, and judges abnormality of the new learned neural network model based on a result of the statistical processing.

### FIELD

The present invention relates to a model diagnosis device and a model diagnosis system.

### BACKGROUND

In the past, it has been known to use a neural network model outputting a predetermined output parameter from predetermined input parameters for control of a vehicle. For example, PTL 1 describes using a learned neural network model to estimate an amount of flow of intake gas taken into combustion chambers of an internal combustion engine mounted in a vehicle.

### CITATIONS LIST

### Patent Literature

[PTL 1] Japanese Unexamined Patent Publication No. 2012-112277

### SUMMARY

### Technical Problem

In this regard, in order to improve the precision of a neural network model, it is necessary to perform learning of the neural network model in advance. In learning of a neural network model, sets of training data comprised of combinations of measured values of the input parameters and measured values of the output parameter are used.

The measured values of the input parameters and the output parameter can be acquired using sensors etc., during actual driving of a vehicle. For this reason, it may be considered to prepare sets of training data in a vehicle and perform learning of the neural network model in the vehicle. By transmitting the learned neural network model obtained as a result to a server outside the vehicle, it is possible to distribute the learned neural network model through the server to other vehicles.

However, if an abnormality arises in a part relating to learning of the neural network model, the learning of the neural network model is not suitably performed. As a result, in the vehicle, control is liable to be performed using an abnormal learned neural network model. Further, the abnormal learned neural network model is liable to be distributed to other vehicles.

Therefore, in consideration of the above problem, an object of the present invention is to provide a model diagnosis device able to diagnose an abnormality of a learned neural network model generated in a vehicle.

### Solution to Problem

The summary of the present disclosure is as follows.

(1) A model diagnosis device comprising: a communication device able to communicate with a plurality of vehicles in each of which learning of a neural network model is performed and a learned neural network model is generated; a storage device storing data; and a control device configured to judge abnormality of the learned neural network model, wherein the control device is configured to store values of an output parameter output from the learned neural network model for predetermined values of input parameters in the storage device, when receiving a new learned neural network model or a value of an output parameter output from the new learned neural network model for the predetermined values of the input parameters from one vehicle of the plurality of vehicles through the communication device, performe statistical processing on the value of the output parameter, and judge abnormality of the new learned neural network model based on a result of the statistical processing.

(2) The model diagnosis device described in above (1), wherein the control device is configured to notify the one vehicle that the new learned neural network model is abnormal when judging that the new learned neural network model is abnormal.

(3) The model diagnosis device described in above (1) or (2), wherein the control device is configured to send to the one vehicle a learned neural network model generated at a vehicle different from the one vehicle and judged to be normal when judging that the new learned neural network is abnormal.

(4) The model diagnosis device described in any one of above (1) to (3), wherein the control device is configured to store the new learned neural network model in the storage device when judging that the new learned neural network model is normal, and not to store the new learned neural network model in the storage device when judging that the new learned neural network model is abnormal.

(5) The model diagnosis device described in any one of above (1) to (4), wherein the control device is configured to transmit a corrected neural network model to the plurality of vehicles when the values of the output parameters stored in the storage device are not normally distributed.

(6) A model diagnosis system comprising a server and a plurality of vehicles, wherein each of the plurality of vehicles comprises: a first communication device able to communicate with the server; and a first control device configured to generate a learned neural network model by performing learning of a neural network model, the server comprises: a second communication device able to communicate with the plurality of vehicles; a storage device storing data; and a second control device configured to judge an abnormality of the learned neural network model, and the second control device is configured to store values of an output parameter output from the learned neural network model for predetermined values of input parameters in the storage device, when receiving a new learned neural network model or a value of an output parameter output from the new learned neural network model for the predetermined values of the input parameters from one vehicle of the plurality of vehicles through the second communication device, perform statistical processing on the value of the output parameter and judge abnormality of the new learned neural network model based on a result of the statistical processing.

(7) The model diagnosis system described in above (6), wherein the second control device is configured to notify the one vehicle that the new learned neural network model is abnormal when judging that the new learned neural network model is abnormal.

(8) The model diagnosis system described in above (7), wherein the first control device is configured not to employ the new learned neural network model when being notified that the new learned neural network model is abnormal.

(9) The model diagnosis system described in above (7) or (8), wherein the first control device is configured to notify a driver of an abnormality of a part relating to learning of the neural network model when being notified that the new learned neural network model is abnormal.

(10) The model diagnosis system described in any one of above (6) to (9), wherein the second control device is configured to perform statistical processing on the value of the output parameter when receiving the value of the output parameter output from the new learned neural network for the predetermined values of input parameters from one vehicle of the plurality of vehicles through the second communication device, judge abnormality of the new learned neural network model based on the result of the statistical processing, and notify the one vehicle that the new learned neural network model is normal when judging that the new learned neural network model is normal, and the first control device is configured to transmit the new learned neural network model to the server when being notified that the new learned neural network model is normal.

### Advantageous Effects of Invention

According to the present invention, there is provided a model diagnosis device able to diagnose an abnormality of a learned neural network model generated in a vehicle.

### BRIEF DESCRIPTION OF DRAWINGS

FIG. 1 is a schematic view of the configuration of a model diagnosis system according to a first embodiment of the present invention.

FIG. 2 is a view schematically showing a part of the configuration of a vehicle of FIG. 1.

FIG. 3 is a view showing one example of a neural network model having a simple configuration.

FIG. 4 is a flow chart showing a control routine of model learning processing in the first embodiment.

FIG. 5 is a flow chart showing a control routine of model diagnosis processing in the first embodiment.

FIG. 6 is a view showing one example of a predetermined range of normal distribution.

FIG. 7 is a flow chart showing a control routine of model learning processing in a second embodiment.

FIG. 8 is a flow chart showing a control routine of model diagnosis processing in the second embodiment.

FIG. 9 is a flow chart showing a control routine of model diagnosis processing in a third embodiment.

### DESCRIPTION OF EMBODIMENTS

Below, referring to the drawings, embodiments of the present invention will be explained in detail. Note that, in the following explanation, similar component elements are assigned the same reference signs.

### First Embodiment

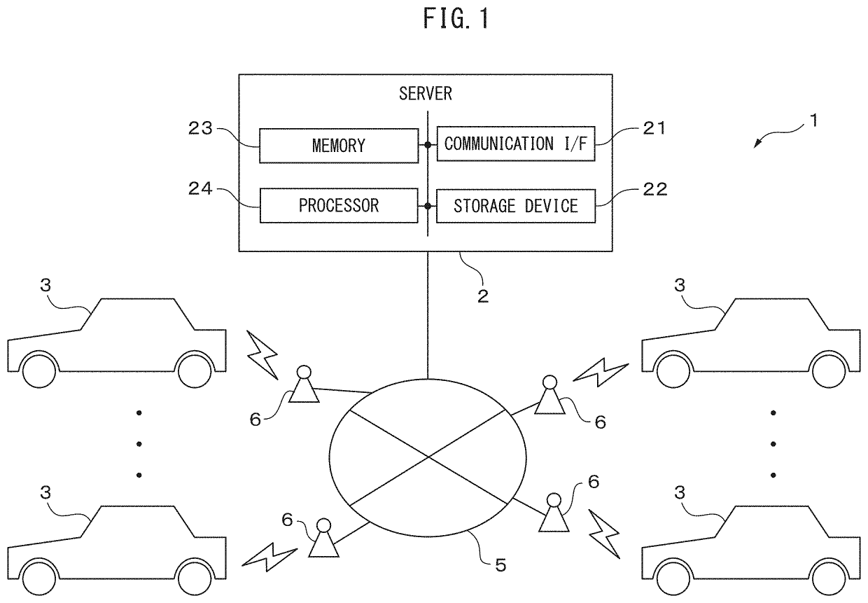

First, referring to FIG. 1 to FIG. 6, a first embodiment of the present invention will be explained. FIG. 1 is a schematic view of a configuration of a model diagnosis system according to the first embodiment of the present invention. The model diagnosis system 1 is provided with a server 2 and a plurality of vehicles 3.

As shown in FIG. 1, the server 2 is provided outside of the plurality of vehicles 3 and is provided with a communication interface 21, storage device 22, memory 23, and processor 24. Note that, the server 2 may be further provided with an input device such as a keyboard and mouse and an output device such as a display etc. Further, the server 2 may be configured by a plurality of computers. The server 2 is one example of a model diagnosis device.

The communication interface 21 can communicate with the plurality of vehicles 3, so the server 2 can communicate with the plurality of vehicles 3. Specifically, the communication interface 21 has an interface circuit for connecting the server 2 to the communication network 5. The server 2 communicates with the plurality of vehicles 3 through the communication interface 21, communication network 5, and wireless base station 6. The communication interface 21 is one example of a communication device.

The storage device 22, for example, has a hard disk drive (HDD), solid state drive (SSD), or optical storage medium. The storage device 22 stores various types of data, for example, stores vehicle information, computer programs for the processor 24 to perform various processing, etc. The storage device 22 is one example of a storage device.

The memory 23, for example, has a semiconductor memory such as a random access memory (RAM). The memory 23, for example, stores various data etc., used when various processing is performed by the processor 24.

The communication interface 21, storage device 22, and memory 23 are connected through signal wires to the processor 24. The processor 24 has one or more CPUs and peripheral circuits and performs various processing. Note that, the processor 24 may further have processing circuits such as arithmetic logic units or numerical calculation units. The processor 24 is an example of a control device.

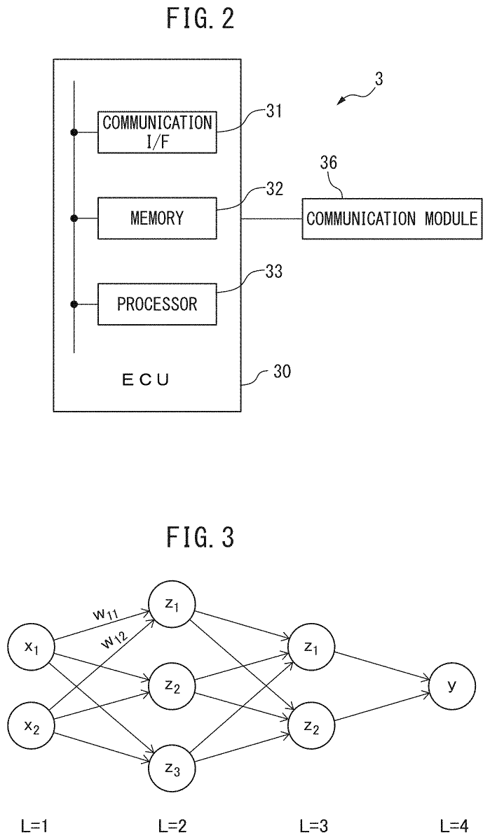

FIG. 2 is a view schematically showing a part of the configuration of a vehicle 3 in FIG. 1. The vehicle 3 is provided with an electronic control unit (ECU) 30. The ECU 30 includes a communication interface 31, memory 32, and processor 33 and performs various control operations of the vehicle 3. Note that, in the present embodiment, a single ECU 30 is provided, but a plurality of ECUs may be provided for the different functions.

The communication interface 31 is an interface circuit for connecting the ECU 30 to an internal vehicle network based on the CAN (Controller Area Network) or other standard. The ECU 30 communicates with other vehicle-mounted devices through the communication interface 31.

The memory 32, for example, has a volatile semiconductor memory (for example, a RAM) and nonvolatile semiconductor memory (for example, a ROM). The memory 32 stores programs run by the processor 33, various data used when the various processings are performed by the processor 33, etc. The memory 32 is one example of a storage device.

The communication interface 31 and memory 32 are connected to the processor 33 through signal wires. The processor 33 has one or more CPUs (central processing units) and their peripheral circuits and performs various processing. Note that, the processor 33 may further have processing circuits such as arithmetic logic units or numerical calculation units. The processor 33 is one example of a control device.

Further, the vehicle 3 is provided with a communication module 36 able to communicate with the outside of the vehicle 3 (for example, the server 2). The communication module 36 is connected to the ECU 30 through a signal wire and is, for example, configured as a data communication module (DCM). The vehicle 3 communicates with the server 2 through the communication module 36, wireless base station 6, and communication network 5. The communication module 36 is one example of a communication device.

In the present embodiment, in the vehicle 3, the control using a neural network model is performed. First, referring to FIG. 3, a neural network model will be explained in outline. FIG. 3 is a view showing one example of a neural network model having a simple configuration.

The circle marks in FIG. 3 show artificial neurons. An artificial neuron is usually called a “node” or “unit” (in this Description, called a “node”). In FIG. 3, L=1 indicates an input layer, L=2 and L=3 indicates hidden layers, and L=4 indicates an output layer. Note that, the hidden layers are also called “intermediate layers”.

In FIG. 3, x₁ and x₂ indicate nodes of the input layer (L=1) and output values from the nodes, while “y” indicates a node of the output layer (L=4) and its output values. Similarly, the z₁^{(L=2)}, z₂^{(L=2)}, and z₃^{(L=2)} indicates nodes of the hidden layers (L=2) and the output values from the nodes, while z₁^{(L=3)} and z₂^{(L=3)} indicate nodes of the hidden layers (L=3) and the output values from the nodes.

At the nodes of the input layer, inputs are output as they are. On the other hand, at the nodes of the hidden layer (L=2), the output values x₁ and x₂ of the nodes of the input layer are input. At the nodes of the hidden layers (L=2), corresponding weights “w” and biases “b” are used to calculate total input values “u”. For example, in FIG. 3, the total input values uₖ^{(L=2)} calculated at the nodes shown by zₖ^{(L=2)} (k=1, 2, 3) of the hidden layer (L=2) become as in the following equation (M is the number of nodes of the input layer).

$${u}_{k}^{( L = 2 )} = {\sum }_{m = 1}^{m} ( {x}_{m} \cdot {w}_{km}^{( L = 2 )} ) + {b}_{k} \qquad [ Equation 1 ]$$

Next, this total input values uₖ^{(L=2)} are converted by the activation function “f” and are output as the output values zₖ^{(L=2)} (=f(uₖ^{(L=2)})) from the nodes shown by zₖ^{(L=2)} of the hidden layers (L=2). On the other hand, the nodes of the hidden layer (L=3) receive as input the output values z₁^{(L=2)}, z₂^{(L=2)}, and z₃^{(L=2)} of the nodes of the hidden layer (L=2). At the nodes of the hidden layer (L=3), the corresponding weights “w” and biases “b” are used to calculate the total input values “u” (=Σz·w+b). The total input values “u” are similarly converted by an activation function and are output from the nodes of the hidden layers (L=3) as the output values z₁^{(L=3)} and z₂^{(L=3)}. The activation function is for example a Sigmoid function σ.

Further, the node of the output layer (L=4) receives as input the output values z₁^{(L=3)} and z₂^{(L=3)} of the nodes of the hidden layer (L=3). At the node of the output layer, the corresponding weights “w” and biases “b” are used to calculate the total input value “u” (Σz·w+b) or only the corresponding weights “w” are used to calculate the total input value “u” (Σz·w). For example, at the node of the output layer, an identity function is used as the activation function. In this case, the total input value “u” calculated at the node of the output layer is output as it is as the output value “y” from the node of the output layer.

The neural network model outputs at least one output parameter from a plurality of input parameters. In the present embodiment, as the input parameters and the output parameter of the neural network model, parameters relating to a state of the vehicle 3, parameters relating to a driving environment of the vehicle 3, etc., are used.

For example, as the input parameters, the outside air temperature, latitude, longitude, day of the week, hours, and immediately preceding parked time (parked time before driving) are used, and as the output parameter, the temperature setting of the air-conditioner is used. When the day of the week is used as an input parameter, the day of the week is converted into a numeral. For example, 1 to 7 are assigned to Monday to Sunday.

Further, if the vehicle is provided with an internal combustion engine as the power source, for example, as the input parameters, the engine speed, opening degree of the throttle valve, intake air amount (total of amount of fresh air and amount of EGR gas) or intake air pressure, temperature of cooling water of the internal combustion engine, angle of the camshaft, intake temperature, vehicle speed, and target air-fuel ratio of the air-fuel mixture are used, and as the output parameter, the amount of correction of the target air-fuel ratio is used.

Further, if the vehicle 3 is provided with an internal combustion engine and motor as power sources, that is, if the vehicle is a hybrid vehicle (HV) or a plug-in hybrid vehicle (PHV), for example, as the input parameters, the state of charge (SOC) of the battery, vehicle speed, accelerator opening degree, temperature of the cooling water of the internal combustion engine, temperature of the battery, electrical load due to use of the air-conditioner etc., atmospheric pressure or elevation, latitude of the current location, longitude of the current location, day of the week, and hours are used, and as the output parameter, the target amount of charging and discharging of the battery in the HV mode is used. Note that, in the HV mode, the internal combustion engine and motor are driven so that the SOC of the battery becomes the target value.

At the vehicle 3, sensors required for detecting the measured values of the input parameters and the output parameter are provided in accordance with the types of the parameters. Further, the neural network model used in the vehicle 3 (specifically, information on the configuration of the neural network model) is stored in the memory 32 of the ECU 30. The information on the configuration of the neural network model includes the number of hidden layers, the number of nodes at each layer, the weights “w”, the biases “b”, etc.

The processor 33 of the ECU 30 inputs the input parameters to the neural network model so as to make the neural network model output the output parameter. At this time, as the values of the input parameters, for example, values detected by sensors etc., provided at the vehicle 3, values calculated by the processor 33, values obtained by information sent from the outside of the vehicle 3 to the vehicle 3, values input by the driver, etc., are used. By using the neural network model, it is possible to obtain suitable values of the output parameter corresponding to predetermined values of the input parameters.

In order to improve the precision of the neural network model, it is necessary to perform learning of the neural network model in advance. In the present embodiment, in each of the plurality of vehicles 3, learning of the neural network model is performed and a learned neural network model is generated. Specifically, the processor 33 of the ECU 30 performs learning of a neural network model to thereby generate a learned neural network model. That is, in the present embodiment, learning of the neural network model is performed not in the server 2, but in the vehicles 3.

In learning of the neural network model, sets of training data comprised of combinations of measured values of the plurality of input parameters and the measured values (ground truth data) of at least one output parameter corresponding to these measured values are used. For this reason, in order to prepare the sets of training data, the processor 33 of the ECU 30 acquires the measured values of the plurality of input parameters and the measured values of the at least one output parameter corresponding to these measured values. The measured values of the input parameters and the output parameters are, for example, acquired as values detected by sensors etc., provided at the vehicle 3, values calculated by the processor 33, values obtained by information sent from the outside of the vehicle 3 to the vehicle 3, values input by the driver, etc. The sets of training data prepared by combining these measured values are stored in the memory 32 of the ECU 30.

The processor 33 uses a large number of sets of training data to perform learning of the neural network model. For example, the processor 33 repeatedly updates the weights “w” and biases “b” in the neural network model by the known error backpropagation method so that the differences between the values output by the neural network model and the measured values of the output parameter become smaller. As a result, the neural network model is learned and a learned neural network model is generated. The learned neural network model (specifically, the information of the configuration of the learned neural network model) is stored in the memory 32 of the ECU 30. The information of the configuration of the learned model includes the number of hidden layers, the number of nodes in each layer, the weights “w”, biases “b”, etc.

The learned neural network model (below, referred to as the “learned model”) is used in a vehicle 3 for control of the vehicle 3. By using the learned model, it is possible to predict a value of the output parameter corresponding to values of the input parameters before detecting the measured value of the output parameter by a sensor etc.

In the present embodiment, if a learned model is generated at a vehicle 3, the learned model is sent from the vehicle 3 to the server 2. That is, the learned models generated at the plurality of vehicles 3 are collected at the server 2. At this time, the learned models generated at the vehicles 3 are stored in the storage device 22 of the server 2.

The learned model is distributed from the server 2 to other vehicles according to need. By doing this, the learned model can be used even in a vehicle not having a learning function of a neural network model or a vehicle in which learning of a neural network model has not finished.

However, if an abnormality arises in a part relating to learning of a neural network model (sensors detecting measured values of the input parameters and the output parameters, ECU 30 performing learning of the neural network model, etc.), learning of the neural network model is not suitably performed. As a result, in a vehicle 3, control is liable to be performed using an abnormal learning model. Further, an abnormal learned model is liable to be distributed from the server 2 to other vehicles.

For this reason, in the present embodiment, in the server 2, abnormality of the learned model is diagnosed, and the processor 24 of the server 2 judges abnormality of the learned model. If the learned model is abnormal, the values of the weights “w” and biases “b” become off from the suitable ranges and unsuitable values of the output parameter are output from the learned model. Therefore, if the same values are input to a large number of learned models as input parameters, there is a high possibility that the values of an output parameter output from an abnormal learned model will become statistically deviated values.

For this reason, by statistically processing values of the output parameter output from a learned model, it is possible to diagnose abnormality of the learned model. In the statistical processing, a large number of values of the output parameter become necessary. Further, in order to compare the values of the output parameter, it is necessary to input the same values of input parameters to the learned model when acquiring the values of the output parameter.

For this reason, the processor 24 of the server 2 stores in the storage device 22 the values of the output parameter output from a learned model for predetermined values of input parameters. At this time, the values of the output parameter are acquired by inputting the predetermined values of input parameters into the learned model. The predetermined values are predetermined sets of values and are stored in the storage device 22. For example, if the number of input parameters of the learned model is six, values are set in advance for each of the six input parameters. That is, if the weights “w” and biases “b” in two learned models generated at different vehicles 3 are set to the same values, the values of the output parameters output from the two learned models for the predetermined values of input parameters become the same.

Further, when receiving a new learned model from one vehicle 3 of the plurality of vehicles 3 through the communication interface 21 of the server 2, the processor 24 statistically processes the value of the output parameter output from the new learned model for the predetermined values of input parameters and judges abnormality of the new learned model based on the result of the statistical processing. By doing this, it is possible to separate out a learned model outputting a deviated value as the output parameter and in turn possible to precisely diagnose abnormality of a learned model in a short time period.

For example, when a value of the output parameter output from a new learned model is within a predetermined range of normal distribution generated using the values of the output parameter stored in the storage device 22 as a population, the processor 24 judges that the new learned model is normal. On the other hand, when the value of the output parameter output from the new learned model is outside the predetermined range of normal distribution, the processor 24 judges that the new learned model is abnormal.

Further, the processor 24 sends the result of diagnosis of abnormality of the new learned model to the vehicle 3 sending the new learned model to the server 2. By doing this, in the vehicle 3, it is possible to judge whether to use the new learned model.

Specifically, when judging that the new learned model is abnormal, the processor 24 notifies the vehicle 3 that the new learned model is abnormal. On the other hand, when judging that the new learned model is normal, the processor 24 notifies the vehicle 3 that the new learned model is normal.

Further, when distributing the learned model to other vehicles, the processor 24 sends the learned model judged to be normal to the other vehicles. By doing this, in the other vehicles, it is possible to keep control from being performed using an abnormal learning model.

When notified that the new learned model is normal, the processor 33 of the ECU 30 provided at the vehicle 3 sending the new learned model employs the new learned model, while when notified that the new learned model is abnormal, it does not employ the new learned model. By doing this, at the vehicle 3, it is possible to keep control from being performed using an abnormal learned model.

Further, when notified that the new learned model is abnormal, the processor 33 of the ECU 30 notifies the abnormality of a part relating to learning of the neural network model (sensors for detecting measured values of input parameters and the output parameters, ECU 30 performing learning of the neural network model, etc.) to the driver of the vehicle 3. By doing this, the driver can be prompted to repair the vehicle 3.

<Model Learning Processing>

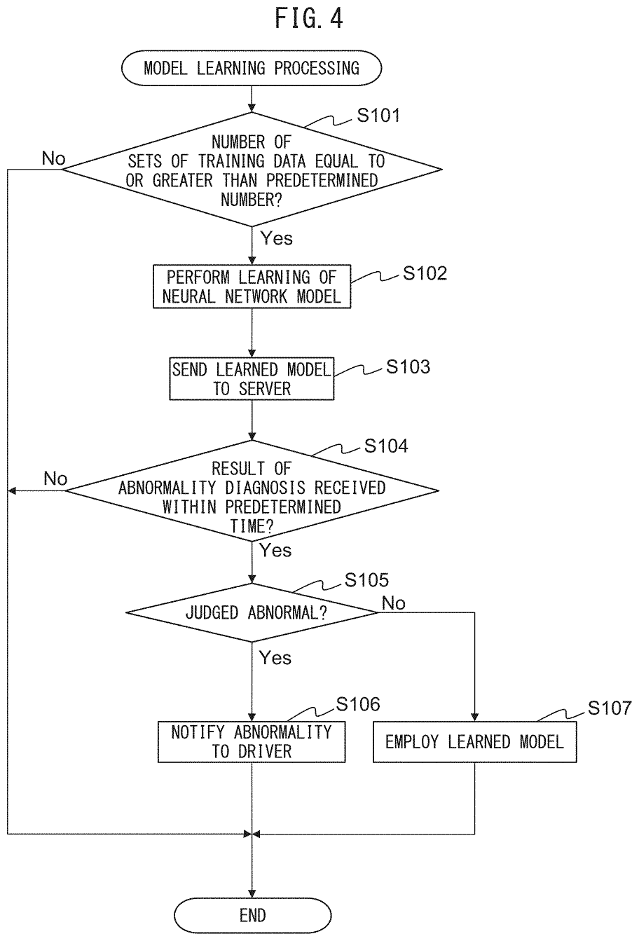

Below, referring to the flow chart of FIG. 4, control performed in the vehicle 3 will be explained in detail. FIG. 4 is a flow chart showing the control routine of model learning processing in the first embodiment. The present control routine is repeatedly performed by the processor 33 of the ECU 30.

First, at step S101, the processor 33 judges whether the number of sets of training data stored in the memory 32 is equal to or greater than a predetermined number. The predetermined number is set in advance and is set to a value sufficient for raising the precision of learning. Note that, if the learning of the neural network model has already been performed, it is judged whether the number of sets of training data not being used for learning, that is, the number of sets of training data newly acquired, is equal to or greater than a predetermined number.

If at step S101 it is judged that the number of sets of training data is less than the predetermined number, the present control routine ends. On the other hand, if at step S101 it is judged that the number of sets of training data is equal to or greater than the predetermined number, the control routine proceeds to step S102.

At step S102, the processor 33 performs learning of the neural network model. For example, the processor 33 uses the known error backpropagation method to repeatedly update the weights “w” and biases “b” in the neural network model so that the differences between the values output by the neural network model and the measured values of the output parameter become smaller. As a result, the neural network model is learned and the learned model is generated. The generated learned model is stored in the memory 32 of the ECU 30.

Next, at step S103, the processor 33 sends the learned model through the communication module 36 to the server 2.

Next, at step S104, the processor 33 judges whether it has received a result of abnormality diagnosis from the server 2 within a predetermined time from when sending the learned model to the server 2. The predetermined time is set in advance and is set to a time longer than the time required for diagnosis of abnormality of the learned model in the server 2. If at step S104 it is judged that the result of abnormality diagnosis has not been received within the predetermined time, the present control routine ends. In this case, the processor 33 does not employ the learned model.

On the other hand, if at step S104 it is judged that the result of abnormality diagnosis has been received within the predetermined time, the control routine proceeds to step S105. At step S105, the processor 33 judges whether the result of abnormality diagnosis is judgment as abnormal. That is, the processor 33 judges whether the learned model being abnormal has been notified. If it is judged that the result of abnormality diagnosis is judgment as abnormal, the control routine proceeds to step S106.

At step S106, the processor 33 notifies the driver of the vehicle 3 of an abnormality in a part relating to learning of the neural network model without employing the learned model. For example, the processor 33 notifies the driver of the vehicle 3 of an abnormality in a part by turning on a warning light provided at the vehicle 3. Note that, the processor 33 may notify the driver of the vehicle 3 of an abnormality in a part by generating a warning sound from a sound generator provided in the vehicle 3. Further, at step S106, the processor 33 may delete the learned model from the memory 32. After step S106, the present control routine ends.

On the other hand, if at step S105 it is judged that the result of abnormality diagnosis is judgment as normal, the control routine proceeds to step S107. At step S107, the processor 33 employs the learned model. As a result, in the subsequent vehicle control, the learned model is used. After step S107, the present control routine ends.

Note that, if at step S104 it is judged that the result of abnormality diagnosis was not received within the predetermined time, the control routine may proceed to step S107. That is, so long as not being notified that the learned model is abnormal, the processor 33 may employ the learned model.

<Model Diagnosis Processing>

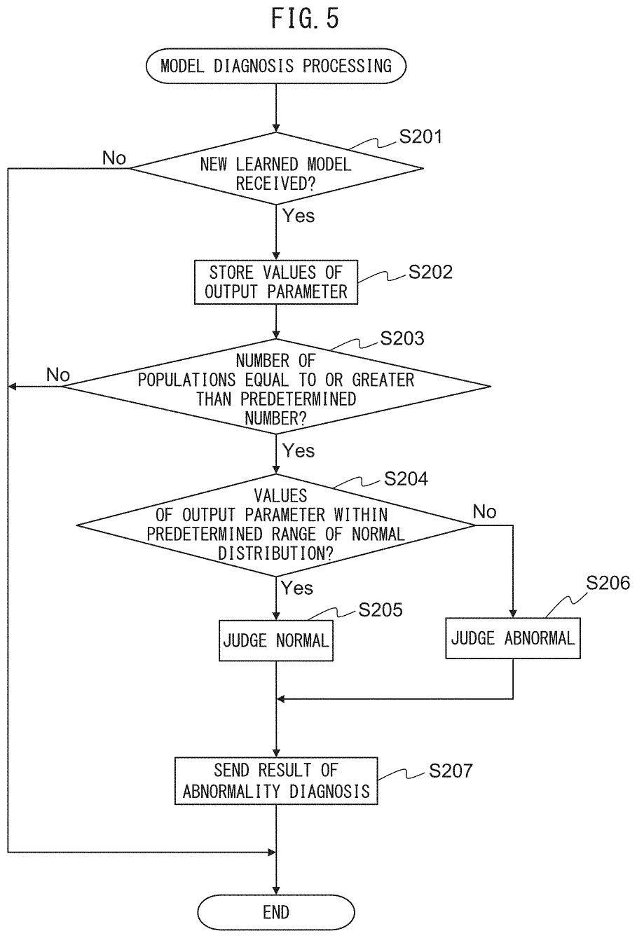

Below, referring to the flow chart of FIG. 5, the control performed at the server 2 will be explained in detail. FIG. 5 is a flow chart showing a control routine of the model diagnosis processing in the first embodiment. The present control routine is repeatedly performed by the processor 24 of the server 2.

First, at step S201, the processor 24 judges whether it has received a new learned model from the vehicle 3. If it is judged that a new learned model has not been received from the vehicle 3, the present control routine ends. On the other hand, if it is judged that a new learned model has been received from the vehicle 3, the control routine proceeds to step S202.

At step S202, the processor 24 stores the value of the output parameter output from the learned model for predetermined values of input parameters in the storage device 22. Specifically, the processor 24 inputs predetermined values of input parameters to the learned model and stores the value of the output parameter output by the learned model in the storage device 22. As explained above, the predetermined values are predetermined sets of values and are stored in the storage device 22.

Next, at step S203, the processor 24 judges whether the number of the values of the output parameter stored in the storage device 22, that is, the number of populations used for statistical processing, is equal to or greater than a predetermined number. The predetermined number is set in advance and is set to a value sufficient for raising the precision of abnormality diagnosis by statistical processing. If it is judged that the number of populations is less than the predetermined number, the present control routine ends. On the other hand, if it is judged that the number of populations is equal to or greater than the predetermined number, the control routine proceeds to step S204.

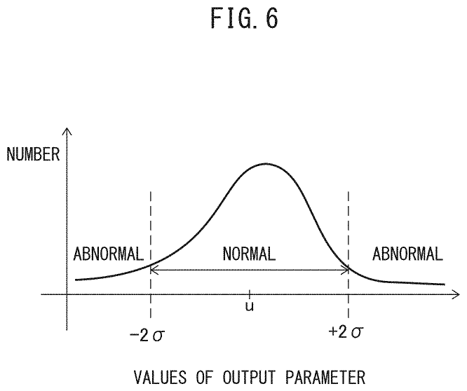

At step S204, the processor 24 judges whether the value of the output parameter output from the new learned model is within a predetermined range of a normal distribution generated using as a population the values of the output parameter stored in the storage device 22. The predetermined range is set in advance and is, for example, set in a “k” sigma section [μ−kσ, μ+kσ]. “k” is any natural number set in advance. “μ” is the average of the normal distribution and is calculated by calculations. σ is the standard deviation of the normal distribution and is calculated by calculations. For example, if “k” is 2, that is, if the predetermined range is the 2 sigma section, as shown in FIG. 6, it is judged that the new learned model is abnormal when the value of the output parameter is not in the range of μ±2σ. Note that, the value of the output parameter output from the new learned model needs not be used as the population.

If at step S204 the values of the output parameter are within a predetermined range of normal distribution, the control routine proceeds to step S205. At step S205, the processor 24 judges that the new learned model is normal. In this case, the processor 24 stores the new learned model (specifically, information of the configuration of the new learned model) in the storage device 22.

After step S205, at step S207, the processor 24 sends the result of abnormality diagnosis to the vehicle 3 sending the new learned model. In this case, the processor 24 notifies the vehicle 3 sending the new learned model that the new learned model is normal. After step S207, the present control routine ends.

On the other hand, if at step S204 it is judged that the value of the output parameter is outside the predetermined range of normal distribution, the control routine proceeds to step S206. At step S206, the processor 24 judges that the new learned model is abnormal. In this case, the processor 24 does not store the new learned model in the storage device 22. That is, the processor 24 deletes the new learned model. Due to this, it is possible to keep the available capacity of the storage device 22 from becoming insufficient.

After step S206, at step S207, the processor 24 sends the result of abnormality diagnosis to the vehicle 3 sending the new learned model. In this case, the processor 24 notifies the vehicle 3 sending the new learned model that the new learned model is abnormal. After step S207, the present control routine ends.

Note that, if, at step S206, the processor 24 judges that the new learned model is abnormal, it may delete the value of the output parameter output from the new learned model judged to be abnormal so that the population does not include deviated values. By doing this, it is possible to keep the precision of abnormality diagnosis from falling.

Further, if, at step S206, the processor 24 judges that the new learned model is abnormal, it may send the vehicle 3 sending the new learned model a normal learned model. The normal learned model is a learned model generated at a vehicle 3 different from the vehicle 3 sending the new learned model and judged to be normal. By doing this, it is possible to perform suitable control using the normal learned model in the vehicle 3 in which the abnormal learned model was generated.

### Second Embodiment

The configuration and control of the model diagnosis system and model diagnosis device according to a second embodiment are basically similar to the configuration and control of the model diagnosis system and model diagnosis device according to the first embodiment except for the points explained below. For this reason, below, the second embodiment of the present invention will be explained focusing on parts different from the first embodiment.

As explained above, in abnormality diagnosis of a learned model, the values of the output parameter output from the learned model are used, while the information on the configuration of the learned model is not used. For this reason, in the second embodiment, if a learned model is generated in the vehicle 3, a value of the output parameter output from the learned model for predetermined values is sent to the server 2. That is, values of the output parameter output from the learned model generated at a plurality of vehicles 3 are collected at the server 2 and stored in the storage device 22 of the server 2. The value of the output parameter are acquired by inputting predetermined values of input parameters to the learned model. The predetermined values are set in advance and stored in the memory 32 of the ECU 30.

When receiving a value of the output parameter output from a new learned model for the above predetermined values of input parameters from one vehicle 3 among a plurality of vehicles 3 through the communication interface 21 of the server 2, the processor 24 of the server 2 performs statistical processing on the value of the output parameter and judges abnormality of the new learned model based on the result of statistical processing. By doing this, it is possible to separate out a learned model outputting deviated values as the output parameter and in turn precisely diagnose abnormality of the learned model in a short time.

However, in order to distribute the learned model to other vehicles from the server 2, the learned model generated at a vehicle 3 has to be sent to the server 2. For this reason, if the processor 33 of the ECU 30 is notified that the new learned model is normal, it sends the new learned model to the server 2. Due to this, it is possible to reduce the communication load compared with when a learned model is sent to the server 2 every time a learned model is generated.

<Model Learning Processing>

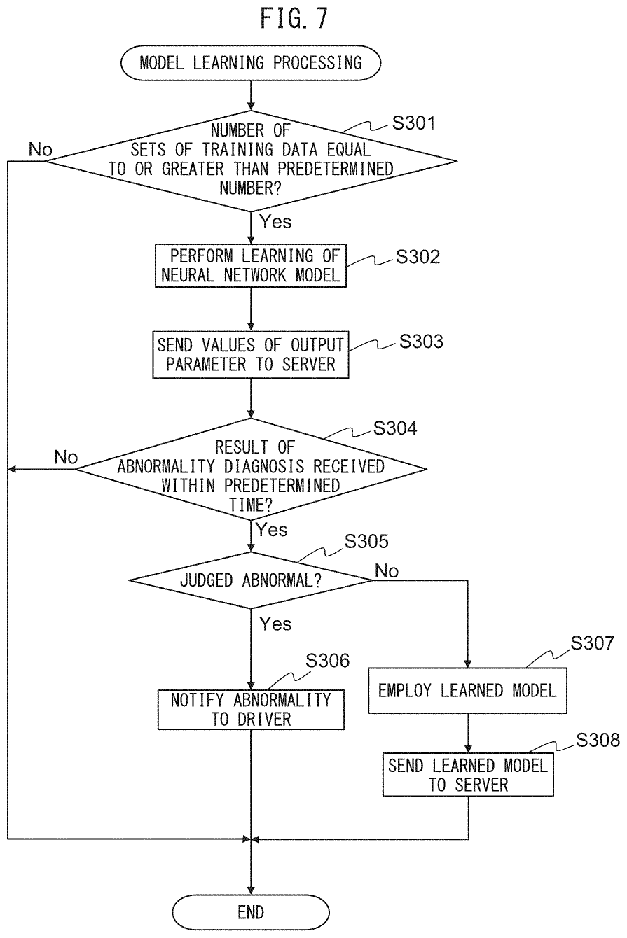

FIG. 7 is a flow chart showing a control routine of model learning processing in the second embodiment. The present control routine is repeatedly performed by the processor 33 of the ECU 30.

First, at step S301, in the same way as step S101 of FIG. 4, the processor 33 judges whether the number of sets of training data stored in the memory 32 is equal to or greater that a predetermined number. It if is judged that the number of sets of training data is less than the predetermined number, the present control routine ends. On the other hand, if at step S301 it is judged that the number of sets of training data is equal to or greater than the predetermined number, the control routine proceeds to step S302.

Next, at step S302, in the same way as step S102 of FIG. 4, the processor 33 performs learning of the neural network model and generates a learned model.

Next, at step S303, the processor 33 sends a value of the output parameter output from the learned model for the predetermined values to the server 2. Specifically, the processor 33 inputs predetermined values of input parameters to the learned model and sends a value of the output parameter output by the learned model to the server 2. As explained above, the predetermined values are predetermined sets of values and are stored in the memory 32.

After that, step S304 to step S306 are performed in the same way as step S104 to step S106 of FIG. 4.

On the other hand, if at step S305 it is judged that the result of abnormality diagnosis is judgment as normal, the control routine proceeds to step S307. At step S307, in the same way as step S107 of FIG. 4, the processor 33 employs the learned model.

Next, at step S308, the processor 33 sends the learned model (specifically, information on the configuration of the learned model) to the server 2. The learned model sent to the server 2 is stored in the storage device 22 of the server 2 and is distributed to other vehicles in accordance with need. Therefore, if judging that the new learned model is normal, the processor 24 of the server 2 stores the new learned model in the storage device 22. After step S308, the present control routine ends.

Note that, the present control routine can be modified in the same way as the control routine of FIG. 4.

<Model Diagnosis Processing>

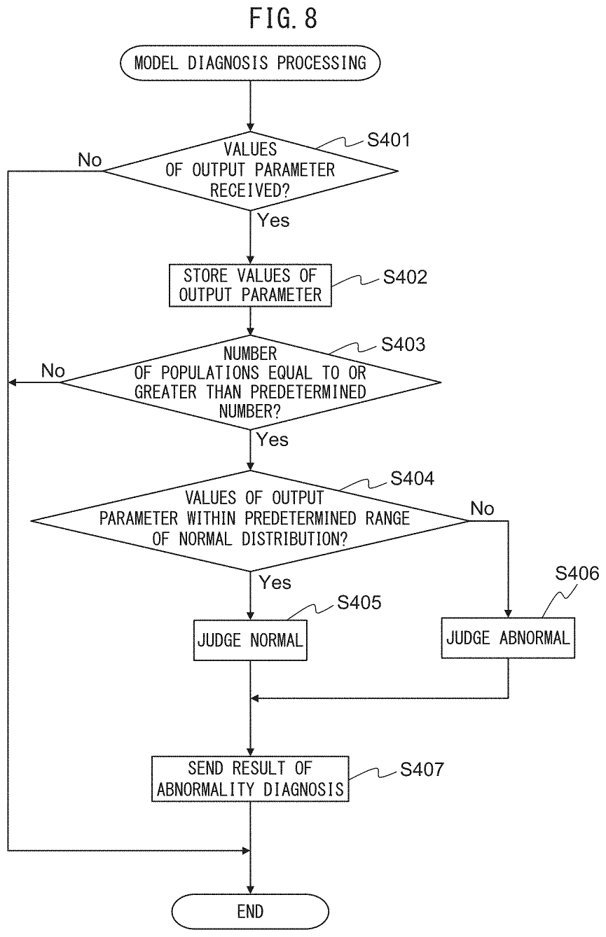

FIG. 8 is a flow chart showing a control routine of model diagnosis processing in the second embodiment. The present control routine is repeatedly performed by the processor 24 of the server 2.

First, at step S401, the processor 24 judges whether it has received a value of the output parameter from the vehicle 3. If it is judged that it has not received a value of the output parameter from the vehicle 3, the present control routine ends. On the other hand, if it is judged that it has received a value of the output parameter from the vehicle 3, the control routine proceeds to step S402.

At step S402, the processor 24 stores the value of the output parameter sent from the vehicle 3 in the storage device 22. After that, step S403 to step S407 are performed in the same way as step S203 to step S207 of FIG. 5.

Note that, if, at step S406, the processor 24 judges that the new learned model is abnormal, it may delete the value of the output parameter sent from the vehicle 3 so that the population does not include the deviated values. Due to this, it is possible to keep the precision of abnormality diagnosis from falling.

Further, if, at step S406, the processor 24 judges that the new learned model is abnormal, it may send a normal learned model to the vehicle 3 sending the values of the output parameter. The normal learned model is a learned model generated at a vehicle 3 different from the vehicle 3 sending the value of the output parameter and judged to be normal. Due to this, in the vehicle 3 in which an abnormal learned model is generated, suitable control can be performed using a normal learned model.

### Third Embodiment

The configuration and control of the model diagnosis system and model diagnosis device according to a third embodiment are basically similar to the configuration and control of the model diagnosis system and model diagnosis device according to the first embodiment except for the points explained below. For this reason, below, the third embodiment of the present invention will be explained focusing on parts different from the first embodiment.

As explained above, if an abnormality arises in a part relating to the learning of the neural network model, the learning of the neural network model is not suitably performed and an abnormal learned model is generated. However, even if such a part is normal, if the configuration of the neural network model (number and types of input parameters, number of hidden layers, numbers of nodes of layers, etc.) is unsuitable, the precision of the learned model cannot be raised.

If the precision of the learned model is low, the variation in the values of the output parameter will become greater between learned models generated at different vehicles 3. In this case, there is a high possibility of the values of the output parameter stored in the storage device 22 not being normally distributed.

For this reason, in the third embodiment, if the values of the output parameter stored in the storage device 22 are not normally distributed, the processor 24 of the server 2 sends a corrected neural network model to the plurality of vehicles 3. By doing this, in the plurality of vehicles 3, it is possible to keep low precision learned models from continuing being generated.

<Model Diagnosis Processing>

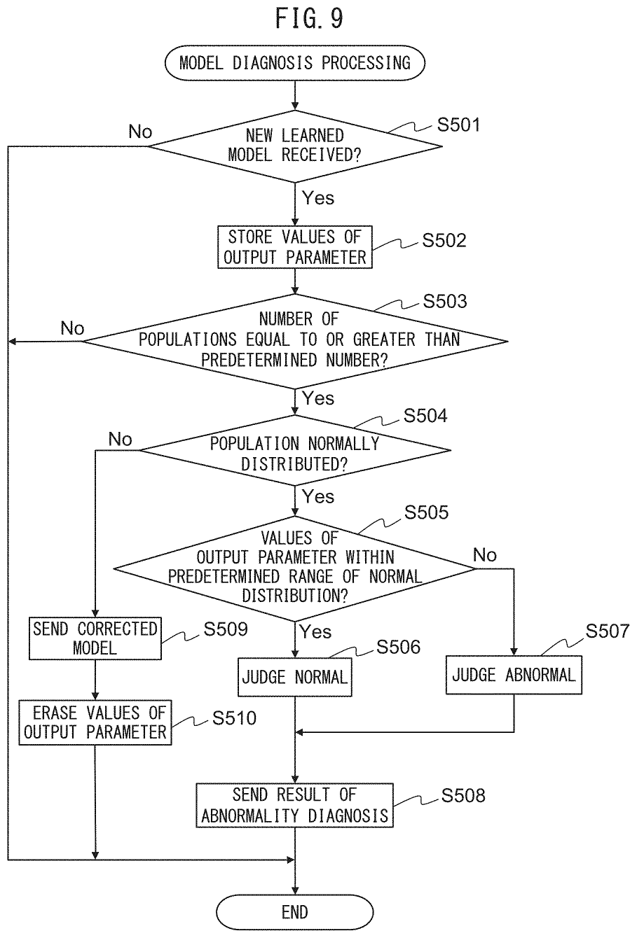

FIG. 9 is a flow chart showing the control routine of model diagnosis processing in the third embodiment. The present control routine is repeatedly performed by the processor 24 of the server 2.

First, step S501 to step S503 are performed in the same way as step S201 to step S203 of FIG. 5. If at step S503, it is judged that the number of populations is equal to or greater than the predetermined number, the control routine proceeds to step S504.

At step S504, the processor 24 judges whether the population comprised of the values of output parameters stored in the storage device 22 is normally distributed. For example, the processor 24 uses a known test method used for testing normality (D'Agostino's test by skewness, D'Agostino's test by kurtosis, omnibus test by skewness and kurtosis, Kolmogorov-Smirnov test, Shapiro-Wilk test, etc.) to judge whether the population is normally distributed.

If at step S504 it is judged that the population is normally distributed, the control routine proceeds to step S505 and step S505 to step S508 are performed in the same way as step S204 to step S207 of FIG. 5. On the other hand, if at step S504 it is judged that the population is not normally distributed, the control routine proceeds to step S509.

At step S509, the processor 24 sends the corrected neural network model to a plurality of vehicles 3. The information on the configuration of the corrected neural network model is stored in the storage device 22. In each of plurality of vehicles 3, the neural network models used in the control of the vehicles 3 are replaced by the corrected neural network model and learning of the corrected neural network model is performed.

For example, the corrected neural network model has a greater number of hidden layers than the neural network model before correction. Note that, the corrected neural network model may have a greater number of nodes of the hidden layers than the neural network model before correction. Basically, the greater the number of hidden layers and the number of nodes of the hidden layers, the greater the degree of freedom of the neural network model and the higher the precision of the learned model. The degree of freedom of the neural network model indicates the sums of the weights “w” and biases “b” in the neural network model.

Next, at step S510, the processor 24 deletes all of the values of the output parameter and all of the learned models stored in the storage device 22. After step S510, the present control routine ends.

Note that, the present control routine can be modified in the same way as the control routine of FIG. 5. Further, the corrected neural network model may have types of input parameters different from the neural network model before correction. Further, the corrected neural network model may have input parameters added from the neural network model before correction. In these cases, the neural network model is corrected by a person. For this reason, if it is judged that the population is not normally distributed, the processor 24 notifies the manager of the server 2 of the proposed correction and the neural network model corrected by the manager is sent from the server 2 to the plurality of vehicles 3.

### OTHER EMBODIMENTS

Above, preferred embodiments according to the present invention were explained, but the present invention is not limited to these embodiments. Various corrections and changes can be made within the language of the claims. For example, the types of the input parameters and the output parameter of the neural network model are not limited to the above examples. Any parameters able to be acquired at the vehicle 3 can be included.

Further, the various information stored in the memory 32 of the ECU 30 may be stored in another storage device provided at the vehicle 3. Further, the various information stored in the storage device 22 of the server 2 may be stored in the memory 23 of the server 2.

Further, as the predetermined values of the input parameters input to the learned model, a plurality of combinations may be used. In this case, the values of the output parameter output from the new learned model for the respective plurality of combinations of input parameters are statistically processed, and for example, when all of the values of the output parameter are in a predetermined range of normal distribution, it is judged that the new learned model is normal.

Further, when statistically processing a value of the output parameter, other known statistical techniques for detecting deviated values (for example, trim average, Smirnov-Grubbs test, box and whisker plot, cluster analysis, etc.) may be used.

Further, the above-mentioned embodiments can be worked combined in any way. If the second embodiment and the third embodiment are combined, in the control routine of FIG. 8, instead of step S404 to step S407, step S504 to step S510 of FIG. 9 are performed.

### REFERENCE SIGNS LIST

1 model diagnosis system
2 server
21 communication interface
22 storage device
24 processor
3 vehicle
30 electronic control unit (ECU)
33 processor
36 communication module

1. A model diagnosis device comprising:
a communication device able to communicate with a plurality of vehicles in each of which learning of a neural network model is performed and a learned neural network model is generated;
a storage device storing data; and
a control device configured to judge abnormality of the learned neural network model, wherein
the control device is configured to store values of an output parameter output from the learned neural network model for predetermined values of input parameters in the storage device, when receiving a new learned neural network model or a value of an output parameter output from the new learned neural network model for the predetermined values of the input parameters from one vehicle of the plurality of vehicles through the communication device, performe statistical processing on the value of the output parameter, and judge abnormality of the new learned neural network model based on a result of the statistical processing.

2. The model diagnosis device according to claim 1, wherein the control device is configured to notify the one vehicle that the new learned neural network model is abnormal when judging that the new learned neural network model is abnormal.

3. The model diagnosis device according to claim 1, wherein the control device is configured to send to the one vehicle a learned neural network model generated at a vehicle different from the one vehicle and judged to be normal when judging that the new learned neural network is abnormal.

4. The model diagnosis device according to claim 1, wherein the control device is configured to store the new learned neural network model in the storage device when judging that the new learned neural network model is normal, and not to store the new learned neural network model in the storage device when judging that the new learned neural network model is abnormal.

5. The model diagnosis device according to claim 1, wherein the control device is configured to transmit a corrected neural network model to the plurality of vehicles when the values of the output parameters stored in the storage device are not normally distributed.

6. A model diagnosis system comprising a server and a plurality of vehicles, wherein
each of the plurality of vehicles comprises:
a first communication device able to communicate with the server; and
a first control device configured to generate a learned neural network model by performing learning of a neural network model,
the server comprises:
a second communication device able to communicate with the plurality of vehicles;
a storage device storing data; and
a second control device configured to judge an abnormality of the learned neural network model, and
the second control device is configured to store values of an output parameter output from the learned neural network model for predetermined values of input parameters in the storage device, when receiving a new learned neural network model or a value of an output parameter output from the new learned neural network model for the predetermined values of the input parameters from one vehicle of the plurality of vehicles through the second communication device, perform statistical processing on the value of the output parameter and judge abnormality of the new learned neural network model based on a result of the statistical processing.

7. The model diagnosis system according to claim 6, wherein the second control device is configured to notify the one vehicle that the new learned neural network model is abnormal when judging that the new learned neural network model is abnormal.

8. The model diagnosis system according to claim 7, wherein the first control device is configured not to employ the new learned neural network model when being notified that the new learned neural network model is abnormal.

9. The model diagnosis system according to claim 7, wherein the first control device is configured to notify a driver of an abnormality of a part relating to learning of the neural network model when being notified that the new learned neural network model is abnormal.

10. The model diagnosis system according to claim 6, wherein
the second control device is configured to perform statistical processing on the value of the output parameter when receiving the value of the output parameter output from the new learned neural network for the predetermined values of input parameters from one vehicle of the plurality of vehicles through the second communication device, judge abnormality of the new learned neural network model based on the result of the statistical processing, and notify the one vehicle that the new learned neural network model is normal when judging that the new learned neural network model is normal, and
the first control device is configured to transmit the new learned neural network model to the server when being notified that the new learned neural network model is normal.
